(19) United States
(12) Patent Application Publication
(10) Pub. No.: US 2021/0082031 A1
(43) Pub. Date: Mar. 18, 2021

(54) ORDER PROCESSING METHOD AND DEVICE, AND GOODS VOLUME ESTIMATION METHOD AND DEVICE

(71) Applicant: BEIJING GEEKPLUS TECHNOLOGY CO., LTD., Beijing (CN)

(72) Inventors: Kai LIU, Beijing (CN); Zhaoming BAI, Beijing (CN); Zheng WANG, Beijing (CN)

(73) Assignee: BEIJING GEEKPLUS TECHNOLOGY CO., LTD., Beijing (CN)

(21) Appl. No.: 16/960,893

(22) PCT Filed: Jun. 19, 2019
(86) PCT No.: PCT/CN2019/091876

§ 371 Date: Jul. 9, 2020

(30) Foreign Application Priority Data
Jul. 2, 2018 (CN) 201810706714.2
Sep. 28, 2018 (CN) 201811141989.2

(51) Int. Cl. G06Q 30/06

(52) U.S. Cl. CPC G06Q 30/0635; G06Q 30/0639

(57) ABSTRACT

An order processing method and device, a server, and a storage medium, includes determining an actual volume of at least one item associated with an order, wherein the actual volume of each item is determined on the basis of a historical maximum storage quantity of a given item in a goods location and the volume of the goods location, or on the basis of a storage quantity of a given item in a transfer box and the volume of the transfer box. On the basis of the actual volume of the at least one item associated with the order, determining a total volume of the at least one item associated with the order; and on the basis of the total volume of the at least one item associated with the order and the volume of the transfer box, allocating transfer boxes for the order.

### CROSS-REFERENCE TO THE RELATED APPLICATIONS

This application is the national stage entry of to International Application No. PCT/CN2019/091876, filed on Jun. 19, 2019, designating the United States, and claiming priority to Chinese patent application No. 201810706714.2, filed with Chinese Patent Office on Jul. 2, 2018, and Chinese patent application No. 201811141989.2, filed with Chinese Patent Office on Sep. 28, 2018, which are incorporated herein by reference.

### TECHNICAL FIELD

The present application relates to the technical field of logistics and warehousing, for example, to an order processing method and device, a server and a storage medium, and to a goods volume estimation method and device, a computer device and a storage medium.

### BACKGROUND

A sorting system based on mobile robot, in which shelves are transported by mobile robots, changes a traditional “person-to-goods” sorting mode into a “goods-to-person” mode, to effectively improve operation efficiency, reduce labor costs, and increase production capacity. As it breaks the traditional goods sorting mode, the operation efficiency is effectively improved. However, with the improvement of transport efficiency of the robot, many innovations have been made to the robot sorting system to meet the needs of various industries, and the efficiency of manual sorting from a sorting station to an allocating wall directly influences the sorting efficiency of the entire work.

On the one hand, a turnover box is a carrier of goods movement in a sorting process, and its moving speed and filling degree determine the sorting efficiency. After goods are sorted manually at a workstation, the goods are put into the turnover box. On the one hand, if much empty space is left in the turnover box, it is a waste of space, transport times of the turnover box is also increased, and thus the sorting efficiency is reduced. On the other hand, if the turnover box cannot contain the items, splitting of the items in the turnover box is required, thereby increasing manual operations.

To solve the above problems, a direct measurement method is currently used to obtain the volume of the goods, and a turnover box is allocated to an order according to the volume of the turnover box and the volume of the goods. This method reduces, to some extent, the number of times of manually splitting for turnover boxes or the probability that a turnover box is not full. However, the above problems still exist due to the irregularity or casing manner of items. Therefore, it is very necessary to provide a new method for allocating a turnover box to an order.

On the other hand, in the “goods-to-person” robot system in the warehouse and logistics industry, a combination of “Warehouse Management System (WMS) and robots” is adopted, where robots are dispatched to transport appropriate shelves for sorting, stacking, stocktaking and other warehousing operations. The “goods-to-person” robot system relies on big data and intelligent algorithms to achieve intelligent warehousing. Goods volume information is a type of important basic information in the big data of warehousing, and relatively accurate goods volume information is required in location recommendation of a stacking process and in the box shape recommendation in packing.

At present, methods for collecting goods volume information mainly include offer by upstream suppliers or goods owners, manual measurement by persons, and measurement by equipment. The aforementioned various collecting methods have disadvantages respectively as follows: in the first method, when an upstream supplier or goods owner offers goods volume information, complete goods volume information may be not provided or the provided goods volume information is inaccurate; in the second method, when the goods volume is measured manually, the manual workload in a warehouse may be increased, especially for warehouses where new items are frequently put in storage, manual measurement takes a long time and occurs at a high frequency, which takes a lot of manpower; and in the third method, when a goods volume is measured by equipment, the cost of measurement is relatively high, and it also needs to add a process of measuring the goods volume as compared with direct offer of the goods volume from upstream.

### SUMMARY

Embodiments of the present application provide an order processing method and device, a server and a storage medium, by means of which a turnover box is reasonably allocated to an order, thereby reducing transfer times of the turnover box and manual order splitting operations, thus improving the sorting efficiency.

In a first aspect, an embodiment of the present application provides an order processing method, the method including: determining an actual volume of at least one type of items associated with an order, where an actual volume of at least one type of items is determined based on a historical maximum storage quantity of the items in a location and the volume of accommodation in the location, or determined based on a storage quantity of the items in a turnover box and the volume of the turnover box; determining a total volume of at least one type of items associated with the order according to the actual volume of at least one type of items associated with the order; and allocating a turnover box is allocated to the order according to the total volume of at least one type of items associated with the order and the volume of the turnover box.

In a second aspect, an embodiment of the present application further provides an order processing device, the device comprising: an actual volume determination module configured to determine an actual volume of at least one type of items associated with an order, wherein the actual volume of each type of items is determined based on a historical maximum storage quantity of the items in a location and the volume of accommodation in the location, or determined based on a storage quantity of the items in a turnover box and the volume of the turnover box; a total volume determination module configured to determine a total volume of at least one type of items associated with the order according to the actual volume of at least one type of items associated with the order; and an allocation module configured to allocate a turnover box to the order according to the total volume of at least one type of items associated with the order and the volume of the turnover box.

In a third aspect, an embodiment of the present application further provides a server, the server including: one or more processors; and a storage device configured to store one or more programs, where the one or more programs, when executed by the one or more processors, cause the one or more processors to implement the aforementioned order processing method.

In a fourth aspect, an embodiment of the present invention further provides a storage medium storing a computer program that, when executed by a processor, executes the aforementioned order processing method.

According to the order processing method and device, the server and the storage medium provided in the embodiments of the present application, an actual volume of items is provided based on a historical maximum storage quantity of the goods in a location and the volume of accommodation in the location, or determined based on a storage quantity of the items in a turnover box and the volume of the turnover box; a total volume is obtained by combining the actual volumes of items associated with an order; a turnover box is reasonably allocated to the order according to the total volume and the volume of the turnover box, thereby avoiding the phenomenon that a turnover box is not full or items exceed a turnover box due to goods volume inaccuracy, and reducing transfer times of the turnover box and manual order splitting operations, thus improving the sorting efficiency.

In a fifth aspect, an embodiment of the present application further provides a goods volume estimation method, the method including: when detecting that a new stacking operation of a current SKU items is completed, searching for a location set involved in the new stacking operation; for each location in the location set, determining a current upper limit of unit volume of the current SKU items in the location according to a location volume of accommodation in the location and a storage quantity of the current SKU items in the location; and updating a historical volume of the current SKU items according to the corresponding current upper limit of unit volume of the current SKU items on each location.

In a sixth aspect, an embodiment of the present application further provides a device for calculating goods volume, the device including: a stacking location search module configured to, when detecting that a new stacking operation of a current SKU items is completed, search for a location set involved in the new stacking operation; a current volume upper limit determination module configured to, for each location in the location set, determine a current upper limit of unit volume of the current SKU items in the location according to a location volume of accommodation in the location and a storage quantity of the current SKU items in the location; and a volume update module configured to update a historical volume of the current SKU items according to the corresponding current upper limit of unit volume of the current SKU items on each location.

In a seventh aspect, an embodiment of the present application further provides a computer device, the computer device including: one or more processors; a storage device configured to store one or more programs, where the one or more programs, when executed by the one or more processors, cause the one or more processors to implement the aforementioned goods volume estimation method.

In an eighth aspect, an embodiment of the present application further provides a computer-readable storage medium storing a computer program that, when executed by a processor, implements the method for estimating goods volume as described above.

Embodiments of the present application provide a method and device for estimating goods volume, a computer device and a storage medium. The method includes: when detecting that a new stacking operation of an item having the current SKU is completed, searching for a stacking location set involved in the new stacking operation for each stacking location in the stacking location set, determining a corresponding current upper limit of unit volume of the items having the current SKU on the stacking location according to a location volume of the stacking location and a storage quantity of the items having the current SKU in the stacking location; and updating a historical volume of the items having the current SKU according to the corresponding current upper limit of unit volume of the items having the current SKU on each stacking location. The technical solution of the embodiment of the present application not only can achieve the maintenance of a relatively accurate volume for each SKU item in the warehouse; compared with an actually measured volume, the volume calculated in this solution of the embodiment can better reflect the space occupied by the items, and this can also reduce equipment costs and labor costs.

Described above in the application is only a summary of the technical solutions of the present application. To understand the technical means of the present application more clearly so as to be carry them out in accordance with the content of the specification, and to make the above and other objectives, features and advantages of the present application more apparent and easily understood, specific implementations of the present application are exemplified below.

### BRIEF DESCRIPTION OF THE DRAWINGS

By reading the detailed description of the non-restrictive embodiments with reference to the following drawings, other features, objectives and advantages of the present application will become more apparent.

FIG. 1 is a system structure diagram of a goods sorting system applicable to an embodiment of the present application;

FIG. 2 is a flow diagram of an order processing method provided in Embodiment 1 of the present application;

FIG. 3 is a flow diagram of an order processing method provided in Embodiment II of the present application;

FIG. 4 is a flow diagram of an order processing method provided in Embodiment III of the present application;

FIG. 5 is a structural block diagram of an order processing device provided in Embodiment IV of the present application;

FIG. 6 is a schematic structural diagram of a server provided in Embodiment V of the present invention;

FIG. 7 is a schematic structural diagram of a clapboard shelf provided in an embodiment of the present invention;

FIG. 8 is a schematic flow diagram of a goods volume estimation method provided in Embodiment VII of the present invention;

FIG. 9 is a schematic flow diagram of a goods volume estimation method provided in Embodiment VIII of the present invention;

FIG. 10 is a schematic structural diagram of a device for goods volume estimation provided in Embodiment IX of the present invention; and

FIG. 11 is a schematic structural diagram of a server provided in Embodiment X of the present application.

### DETAILED DESCRIPTION OF THE EMBODIMENTS

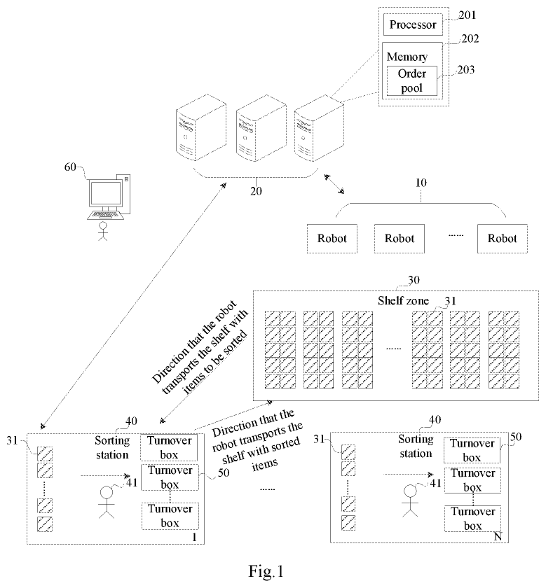

Referring to a system structure diagram of a goods sorting system shown in FIG. 1, the goods sorting system 100 includes self-driving robots 10, a control system 20, a shelf zone 30, and a sorting station 40. The shelf zone 30 is provided with a plurality of shelves 31, and various goods are placed on the shelves 31. For example, like shelves with various goods placed thereon as seen in a supermarket, a plurality of shelves 31 are arranged in array.

The control system 20 communicates with the self-driving robot 10 wirelessly, and a working person uses an operation console 60 to operate the control system 20. The self-driving robot 10 performs goods transport tasks under the control of the control system 20. For example, the self-driving robot 10 can travel along an empty space (a part of a passageway of the self-driving robot 10) in the shelf array, move to the foot of a target shelf 31, lift the target shelf 31 by using a lifting mechanism, and carry it to an assigned sorting station 40. In an example, the self-driving robot 10 has a lifting mechanism and an autonomous navigation function. The self-driving robot 10 can travel to the foot of the target shelf 31 and use the lifting mechanism to lift the entire shelf 31 so that the shelf 31 can be moved up and down with the lifting mechanism having a lifting function. In an example, the self-driving robot 10 can travel forward according to two-dimensional code information captured by a camera, and can travel to the foot of the shelf 31 instructed by the control system 20 according to a path determined by the control system 20. The self-driving robot 10 transports the target shelf 31 to the sorting station 40, and a sorting person 41 or a sorting robot sorts goods from the shelf 31 at the sorting station 40 and puts the goods into a turnover box 50 to wait for packing.

The control system 20 is a software system running on a server and having data storage and information processing capabilities, and can be connected to the robot, a hardware input system, and other software systems in a wireless or wired manner. The control system 20 can include one or more servers, and can be a centralized control architecture or a distributed computing architecture. The server has a processor 201 and a memory 202, and an order pool 203 can be provided in the memory 202.

To improve the sorting efficiency and reduce manual operations, a direct measurement method is currently used to obtain the goods volume, and a turnover box is allocated to an order according to the volume of the turnover box and the volume of the item. Although this method reduces, to some extent, the number of times of manually splitting for turnover boxes or the probability that a turnover box is not full, there are still problems that much empty space is left in a turnover box or manually splitting is required for turnover boxes due to the irregularity or casing manner of goods.

Thus, it is of great importance whether an accurate goods volume is acquired. As there are generally many types of items in turnover boxes, so that indirect estimation based on the turnover boxes is relatively difficult. While if types of items in a goods location in the shelf is simple, the volumes of items can be calculated with reference to the quantity of the goods in the goods location.

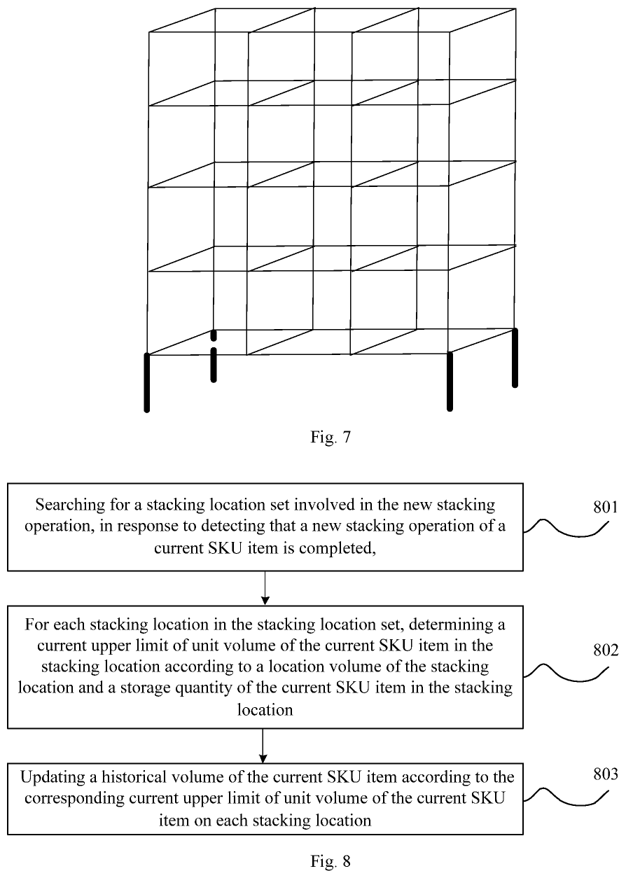

In FIG. 1, a plurality of shelves 31 are arranged in an array. Generally, a plurality of sorting stations 40 are provided at a side of the shelf zone 30. Using a clapboard shelf shown in FIG. 7 as an example, the shelf can include a plurality of goods locations and four floor-standing support columns. Various items can be directly placed on the locations, and one or more Stock Keeping Unit (SKU) items can be placed on each corresponding location in the shelf.

It should be noted that the SKU is a unit for measuring stock-in and stock-out, and can be based on pieces, boxes, and pallets. The SKU is necessary for logistics management of a distribution center (DC) of a large supermarket chain. The SKU involved in the embodiments of the present application can be extended as a short name for a unified number of an item, and each item corresponds to a unique SKU number. The SKU in this embodiment can be understood as a unified number or unique identification number of an item, and various items can be identified by the corresponding SKU codes.

In addition, taking the goods sorting system shown in FIG. 1 as an example, after a sorting person 41 or a sorting robot sorts an item from the shelf 31 at the sorting station 40 and puts the item into a turnover box 50, the sorted item placed into the turnover box need to be packed. To pack the sorted items placed in the turnover box, it first needs to know the volume of the sorted item before recommending a corresponding box type for the sorted item based on the volume information of the sorted item. Of course, the above goods sorting process is only illustrated for example. In addition to the above process, it is also needs to know the volume of items in during location recommendation in a stacking process. However, related collection methods (such as offer by upstream suppliers or goods owners, manual measurement by persons, measurement by equipment, etc.) have some deficiencies in determining the volumes of items, resulting in inefficient maintenance of the volumes of many items in a warehouse. Thus, there is a need for an improved method for determining a goods volume, to maintain a relatively accurate volume for an item of each SKU in the warehouse, and to reduce equipment costs and labor costs.

The present application is further described in detail below in conjunction with the accompanying drawings and embodiments. It can be understood that the embodiments described herein are only used for explaining the present application, rather than limiting the present application. In addition, it should also be noted that, for convenience of description, only parts related to the present application, instead of all the present application, are shown in the drawings.

### Embodiment I

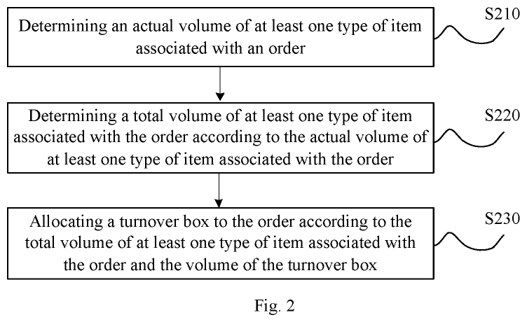

FIG. 2 is a flow diagram of an order processing method according to Embodiment I of the present application. This embodiment is applicable to a scenario of reasonably allocating a turnover box for an order to improve the sorting efficiency. The method can be executed by an order processing device according to an embodiment of the present application, and the device can be embodied in at least one of software and hardware. Referring to FIG. 2, the method includes steps S210, S220 and S230.

S210: determining an actual volume of at least one type of item associated with an order.

The actual volume of each type of item is determined based on a historical maximum storage quantity of the item in a location and the volume of the accommodation in the location, or determined based on a storage quantity of the items in a turnover box and the volume of the turnover box.

The items associated with the order can be the same type of item, or multiple types of items; the same type of items refers to items with the same item number, attribute, etc. For example, a large size and a small size of items can be regarded as two types of items, such as cups. The difference between the actual volume of the item and a true volume of the item is approximate to zero, so the actual volume of the item may also be called a true volume of the item. The volume of accommodation in a location refers to a maximum capacity for containing items in a location on a shelf. It should be noted that each shelf for storing item has the same number of locations, and the volume of accommodation in each location on shelves of the same specification is same. The historical maximum storage quantity of items in a location refers to a storage quantity corresponding to a location storing a largest quantity of a type of items among locations on all shelves those previously stored and now store the items, and can be obtained by traversing the locations of the shelves storing the item in a warehouse.

In an embodiment, an actual volume of item can be determined by estimation based on a location. For example, the volume of accommodation in a location can be divided by a historical maximum storage quantity of item in the location to determine an actual volume of the item.

The turnover box refers to a container for containing item to be sorted; and the volume of a turnover box refers to a volume of a turnover box actually capable of containing item, and is fixed and highly accurate. Its effective available volume limits the number of items and the number of orders. That is, all items in one or more orders can be placed in a turnover box. For subsequent packaging work, in an embodiment, an intelligent sorting system binds an order to a turnover box. The storage quantity of items in a turnover box refers to a maximum storage quantity of the items stored in the turnover box, that is, the quantity of the items contained therein when the turnover box is full of the items.

To reduce operations and further improve the accuracy of an actual volume of item, when only the same type of item are stored in a turnover box, the actual volume of the item may also be calculated based on the turnover box. In an embodiment, the volume of a turnover box can be divided by a storage quantity of items in the turnover box to determine an actual volume of the item.

In an embodiment, an actual volume of item determined based on a location and an actual volume of the item determined based on a turnover box are same, but they may also be different.

It should be noted that each item is allocated a basic table when being put in storage, to store a shelf location, a basic volume value and the like of the item. The basic volume value of item can be obtained through communication via an interface between a supplier and an intelligent sorting system. Or based on an item type, an intelligent sorting system can read an average volume value of the item type from an item statistics table, and place a read result into a basic table of the corresponding item.

The basic volume in the basic table of item can be dynamically adjusted according to the actual situation. In an embodiment, after an actual volume of item is determined based on a location or a turnover box, a basic table of the item can be updated with this volume, and a credibility value of the volume determined currently is marked in the basic table to indicate the accuracy of the actual volume of the item.

Due to high accuracy of the volume of a turnover box, thus a credibility value of an actual volume of item determined based on a turnover box is greater than a credibility value of an actual volume of the item determined based on a location, and the credibility value of the actual volume of the item determined based on a location is greater than a credibility value of a basic volume value of the item. In an embodiment, a credibility value of an actual volume of item determined based on a turnover box can be set to 1; a credibility value of an actual volume of the item determined based on a location can be set to 0.8; and a credibility value of a basic volume value of the item can be set to 0.3.

In an embodiment, after an order is acquired, an actual volume of item can be acquired from a basic table of the item associated with the order according to order information. For example, there are the several situations as follows. In a first situation, if all items in a current order are completely included in all items in historical orders, it indicates that an actual volume of the item are stored in a basic table of the item currently associated with the order, and can be directly obtained from the corresponding basic table. In a second situation, if item currently associated with an order are not included in all items in historical orders, it indicates that there are new item in the current order whose actual volume is not determined and that there are different types of item. In this case, an actual volume of the item can be determined by using a historical maximum storage quantity of the item in a location and the volume of accommodation in the location. In a third situation, if item currently associated with an order are not included in any of all items in historical orders, and the current items are of the same type, an actual volume of the item can be determined by using a historical maximum storage quantity of the item in a location and the volume of accommodation in the location, or a storage quantity of the item in a turnover box and the volume of the turnover box.

Step S220: determining a total volume of at least one type of item associated with the order according to the actual volume of at least one type of item associated with the order.

The total volume is obtained by combining the actual volumes of all items in the order.

Step S230: allocating a turnover box to the order according to the total volume of at least one type of item associated with the order and the volume of the turnover box.

The volume of a turnover box refers to a volume of a turnover box actually capable of containing items, that is, an effective available volume.

In an embodiment, an order is determined according to order information, the quantity of items in the order, an actual volume of the item in the order, order creation time and priority, and the like. The order can be a single one or a combination of multiple orders. The total volume of all items associated with the order is compared with the volume of the turnover box; if the total volume of all items associated with the order is an integer multiple of the volume of the turnover box, the turnover box is allocated to the order; and if not, order processing is repeated to allocate a turnover box for the order.

It should be noted that in practice, one order corresponds to one turnover box, but when a total volume of items in a single order is greater than the volume of a turnover box, to avoid the phenomenon that a turnover box is not full or items run out a turnover box, one or more orders can be combined with the order so that a total volume thereof is equal to an integer multiple of the volume of the turnover box, and then the turnover box is allocated to the order.

In the order processing method according to the embodiment of the present application, an actual volume of item is determined based on a historical maximum storage quantity of the item in a location and the volume of accommodation in the location, or determined based on a storage quantity of the item in a turnover box and the volume of the turnover box; a total volume is obtained by combining the actual volumes of items associated with an order; a turnover box is reasonably allocated to the order according to the total volume and the volume of the turnover box, thereby avoiding the phenomenon that a turnover box is not full or items run out a turnover box due to item volume inaccuracy, and reducing transport times of the turnover box and manual splitting operations, thus improving the sorting efficiency.

### Embodiment II

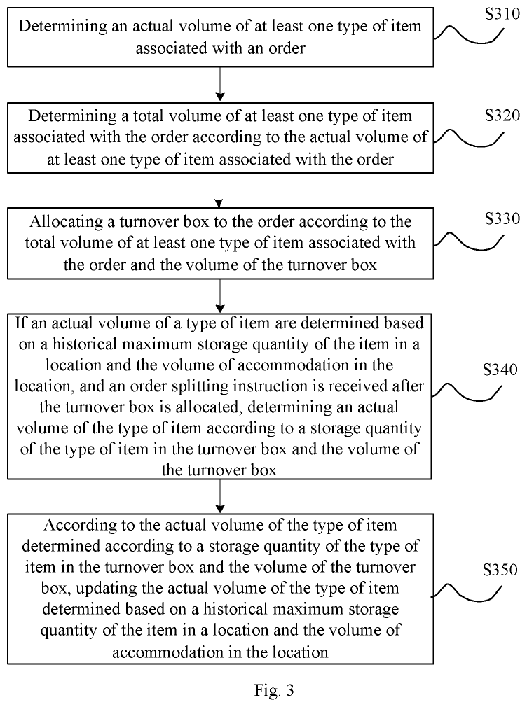

FIG. 3 is a flow diagram of an order processing method provided in Embodiment II of this application. This embodiment explains when to use a turnover box to determine the actual volume of the item. Referring to FIG. 3, the method comprises: steps S310 to S350.

Step S310: determining an actual volume of at least one type of item associated with an order.

The actual volume of each type of item are determined based on a historical maximum storage quantity of the item in a location and the volume of accommodation in the location, or determined based on a storage quantity of the item in a turnover box and the volume of the turnover box.

Step S320: determining a total volume of item associated with the order according to the actual volume of at least one type of item associated with the order.

Step S330: allocating a turnover box to the order according to the total volume of at least one type of item associated with the order and the volume of the turnover box.

Step S340: in the case where an actual volume of a type of item are determined based on a historical maximum storage quantity of the item in a location and the volume of accommodation in the location, and an order splitting instruction is received after the turnover box is allocated, determining an actual volume of the type of item according to a storage quantity of the type of item in the turnover box and the volume of the turnover box.

The order splitting instruction is used for instructing a item sorting system to calculate the quantity of item in the current turnover box and determine the actual volume of the item according to the volume of the turnover box and the quantity of the item.

After an order is acquired, if a credibility value of an actual volume of item acquired from a basic table of the item associated with the order according to order information is 0.8, it can be determined that the actual volume of the current item are determined based on a location. In this case, if a total volume of the item determined according to the actual volume of the item are greater than or less than the volume of the turnover box, and the item associated with the order are the same type of item, to reduce transfer times of the turnover box and improve the sorting efficiency, an actual volume of the item can be calculated again based on the turnover box.

In an embodiment, a sorting workstation is equipped with a touch display screen, which has a manual order splitting button. When a turnover box is full, a sorting person clicks the manual order splitting button on the screen, the item sorting system can automatically read and calculate an actual volume of item in the turnover box, and update a calculation result to a basic table of the item, and update a credibility value marked in the basic table of the item to 1.

It should be noted that if a credibility value of an actual volume of item acquired from a basic table of the item associated with an order is 0.8, and a total volume of the item determined according to the actual volume of the item are equal to the volume of a turnover box, and the item associated with the order are the same type of item, then the credibility value marked in the basic table of the item associated with the order is updated to 1.

Step S350: according to the actual volume of the type of item determined according to a storage quantity of the type of item in the turnover box and the volume of the turnover box, updating the actual volume of the type of item determined based on a historical maximum storage quantity of the item in a location and the volume of accommodation in the location.

In an embodiment, the actual volume of the type of item determined based on a historical maximum storage quantity of the item in a location and the volume of accommodation in the location is replaced with the actual volume of the type of item determined according to a storage quantity of the type of item in the turnover box and the volume of the turnover box; and in an embodiment, for example, a credibility value of the actual volume of the item can be updated.

In the order processing method provided in the embodiment of the present application, after a turnover box is allocated to an order, if there is a phenomenon that an actual volume of item determined based on a location and a total volume of item are greater or less than the volume of the turnover box, and the item associated with the order are the same type of item, an actual volume of the item can be calculated again based on the turnover box to obtain a more accurate actual volume of the item, thereby reducing transfer times of the turnover box, and improving the sorting efficiency.

### Embodiment III

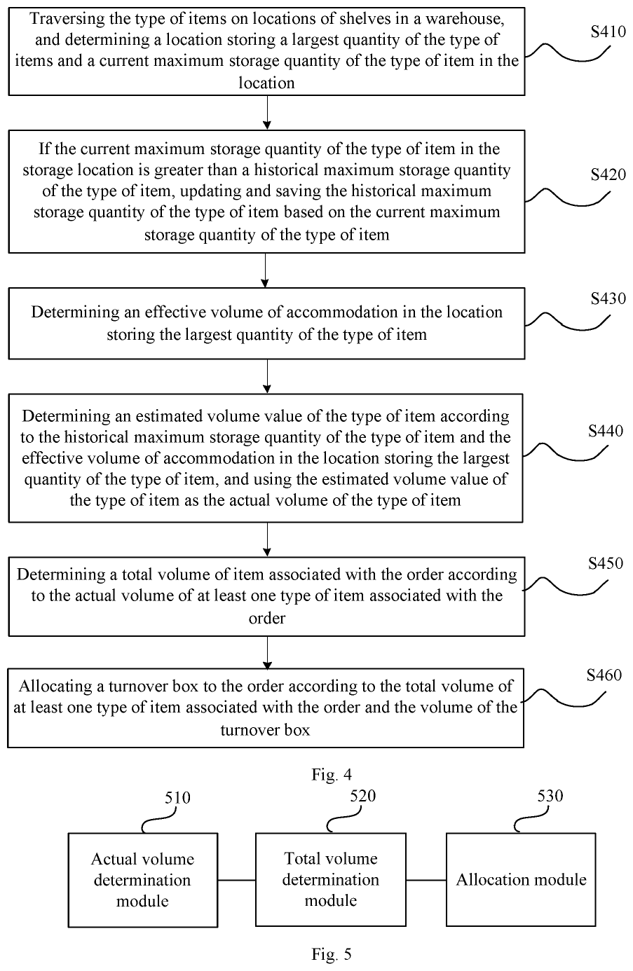

FIG. 4 is a flow diagram of an order processing method provided in Embodiment III of the present application. In this embodiment, the determination of an actual volume of new item is illustrated in detail by using an example that items associated with a current order are not completely included in historical orders, that is, an actual volume of new item in an order has not been determined. Referring to FIG. 4, the method includes steps S410 to S460.

Step S410: traversing the type of items on locations of shelves in a warehouse, and determining a location storing a largest quantity of the type of items and a current maximum storage quantity of the type of item in the location.

In an embodiment, to improve the operating speed of a server, the traversal can be performed every day or periodically when order processing is not performed, by setting a system parameter, such as time. A location storing a largest quantity of the type of item among locations of shelves and a current maximum storage quantity of the type of item in the location can be obtained by successively traversing each type of item associated with an order in the warehouse. The location storing the largest quantity of item, the item number and the quantity of stored item are saved locally according to time.

Step S420: if the current maximum storage quantity of the type of item in the storage location is greater than a historical maximum storage quantity of the type of item, updating and saving the historical maximum storage quantity of the type of item based on the current maximum storage quantity of the type of item.

The historical maximum storage quantity of item refers to a storage quantity corresponding to a location storing a largest quantity of a type of item among locations on all shelves that previously stored and now store the type of item. When the current maximum storage quantity of the item are greater than the historical maximum storage quantity of the item, a value corresponding to the historical maximum storage quantity of the item are replaced with a value corresponding to the current maximum storage quantity of the item and stored locally.

In an embodiment, when the current maximum storage quantity of the item is less than the historical maximum storage quantity of the item, no operation is performed.

Step S430: determining an effective volume of accommodation in the location storing the largest quantity of the type of item.

As locations on each shelf are same, and the volumes of accommodation in the locations are fixed. When the location storing the largest quantity of item are full of the items, the volume of accommodation in the location can be directly determined as the effective volume of accommodation in the location storing the largest quantity of the type of item if the accuracy requirement is not high.

However, due to the limitation of the location, the space of the location cannot be used to 100%. Therefore, the effective volume of accommodation in the location storing the largest quantity of item can be determined according to a space utilization rate in the location.

In an embodiment, determining an effective volume of accommodation in the location storing the largest quantity of the item can includes: calculating an effective volume of accommodation in the location storing the largest quantity of item according to the volume of accommodation in the location storing the largest quantity of the item and a preset threshold of an effective space utilization rate in the location.

The effective volume of accommodation in the location refers to a volume of accommodation in the location capable of containing items. The threshold of the effective space utilization rate in the location is preset according to the actual situation, includes: a maximum upper limit value and lower limit value of the accommodation in the location capable of containing item. The threshold may be obtained by direct measurement, and may also be set by the system based on previous experience. In an embodiment, the maximum upper limit value of the effective space utilization rate in the location may be 98%, and the minimum lower limit value thereof may be 0.

Step S440: determining an estimated volume of the type of item according to the historical maximum storage quantity of the type of item and the effective volume of accommodation in the location storing the largest quantity of the type of item, and using the estimated volume of the type of item as the actual volume of the type of item.

In an embodiment, the volume of accommodation in the location storing the largest quantity of the item is divided by the historical maximum storage quantity of the item to obtain the volume value of the item. In an embodiment, the volume value of the item is determined as the actual volume of the item, and a basic volume value and a credibility value in a basic table of the item are updated and stored.

To reduce the operation, for example, determining the volume value of the item as the actual volume of the item may also be performed by the following steps: determining a basic volume value of the item; and comparing the volume value of the item with the basic volume value of the item, and if they are inconsistent, the volume value of the item is used as the actual volume of the item.

The basic volume value of the item is an initial volume of the item, is pre-stored in the basic table of the item, and can be obtained in any of the following two manners: in a first manner, receiving volume field information of the item, and initializing the basic volume value of the item according to the volume field information; or in a second manner, based on an item type, acquiring an average volume value of the item type from an item statistics table, and initializing the basic volume value of the item according to the average volume value of the item type.

The volume field information refers to information that can be identified by an intelligent sorting system provided by a supplier in a certain field format. The information can include volumes of various items. After the intelligent sorting system receives the volume field information through communication with the supplier via a fixed interface, basic volumes of various items are obtained by processing such as decoding, decryption or decompression. If the volume of a type of item in the volume field information is null or the received volume field information is null, the intelligent sorting system can, based on the item type, read an average volume value of the item type from the item statistics table, and put a reading result into the corresponding basic table of various item to initialize the basic volume values of the various item. The item type refers to a model number, item number and attribute, etc. The item statistics table refers to a table provided by a supplier to record relevant information of item.

In an embodiment, the volume value of the traversed item is compared with the basic volume value in the basic table of the item. In response to determining that they are consistent, the basic volume value of the item is determined as the actual volume of the item, and it only needs to update the credibility value currently marked in the basic table to 0.8; and in response to determining that they are inconsistent, the volume value of the item are used in place of the basic volume value of the item as the actual volume of the item, and the credibility value currently marked in the basic table is updated to 0.8.

Step S450: determining a total volume of item associated with the order according to the actual volume of at least one type of item associated with the order.

Step S460: allocating a turnover box to the order according to the total volume of at least one type of item associated with the order and the volume of the turnover box.

In the order processing method provided in the embodiment of the present application, the items on locations of shelves in a warehouse are traversed to obtain a location storing a largest quantity of the item and a current maximum storage quantity of the item in the location; the current maximum storage quantity of the stored item are compared with a historical maximum storage quantity of the item to update the historical maximum storage quantity of the item; and an actual volume of the item can be obtained according to the historical maximum storage quantity of the item, the volume of accommodation in the location and a basic volume value. This avoids inaccuracy of final calculation of an actual volume of item due to problems such as the irregularity or placing manner of the item in a method of obtaining an actual volume of item by direct measurement in the prior art. Furthermore, a total volume is obtained by combining the actual volumes of item associated with an order; a turnover box is reasonably allocated to the order according to the total volume and the volume of the turnover box, thereby avoiding the phenomenon that a turnover box is not full or item exceed a turnover box due to item volume inaccuracy, and reducing transfer times of the turnover box and manual order splitting operations, thus improving the sorting efficiency.

In an embodiment, after the turnover box is allocated to the order, if the actual volume of the item and the total volume of the item determined based on the location are greater or less than the volume of the turnover box, other turnover box may be adopted. An actual volume of new item are calculated according to the volume of the other turnover box and a determined total volume of other item in the other turnover box.

It should be noted that if items associated with the current order are not included in any historical orders, and such items are of the same type, after a turnover box is allocated to the order by using the steps S410 to S460, if the actual volume of the item and the total volume of the items determined based on the location are greater or less than the volume of the turnover box, the turnover box can be used to re-determine the actual volume of the item, and the actual volume of the item determined based on the location can be replaced with the actual volume of the item determined based on the turnover box.

### Embodiment IV

FIG. 5 is a structural block diagram of an order processing device provided in Embodiment IV of the present application. The device can execute an order processing method provided in any embodiment of the present application, and has corresponding functional modules and beneficial effects for executing the method. As shown in FIG. 5, the device can include: an actual volume determination module 510, a total volume determination module 520 and an allocation module 530.

The actual volume determination module 510 is configured to determine an actual volume of at least one type of item associated with an order, where the actual volume of each type of item is determined based on a historical maximum storage quantity of the item in a location and the volume of accommodation in the location, or determined based on a storage quantity of the items in a turnover box and the volume of the turnover box.

The total volume determination module 520 is configured to determine a total volume of item associated with the order according to the actual volume of at least one type of item associated with the order.

The allocation module 530 is configured to allocate a turnover box to the order according to the total volume of at least one type of item associated with the order and the volume of the turnover box.

In the order processing device provided in the embodiment of the present application, an actual volume of item is determined based on a historical maximum storage quantity of various items in a location and the volume of accommodation in the location, or determined based on a storage quantity of the items in a turnover box and the volume of the turnover box; a total volume is obtained by combining the actual volumes of item associated with an order; a turnover box is reasonably allocated to the order according to the total volume and the volume of the turnover box, thereby avoiding the phenomenon that a turnover box is not full or item exceed a turnover box due to item volume inaccuracy in the prior art, and reducing transport times of the turnover box and manual separations for items in turnover boxes, thus improving the sorting efficiency.

In an embodiment, the actual volume determination module 510 can be configured to: if an actual volume of a type of item is determined based on a historical maximum storage quantity of the item in a location and the volume of accommodation in the location, and an instruction for separating items in the turnover box is received after the turnover box is allocated, determine an actual volume of the type of item according to a storage quantity of the type of item in the turnover box and the volume of the turnover box.

In an embodiment, the above device can further include: an actual volume update module.

The actual volume update module is configured to update the actual volume of the type of item determined based on a historical maximum storage quantity of the item in a location and the volume of accommodation in the location, according to the actual volume of the type of item determined according to a storage quantity of the type of item in the turnover box and the volume of the turnover box.

In an embodiment, the actual volume determination module 510 can further include a location quantity determination unit, a storage quantity update unit, a location volume determination unit, and an actual volume determination unit.

The location quantity determination unit is configured to traverse items on the type of locations of shelves in a warehouse, and determine a location storing a largest quantity of the type of item and a current maximum storage quantity of the type of item in the location.

The storage quantity update unit is configured to, if the current maximum storage quantity of the type of item is greater than a stored historical maximum storage quantity of the item, update and save the historical maximum storage quantity of the type of item according to the current maximum storage quantity of the type of item.

The location volume determination unit is configured to determine an effective space volume of accommodation in the location storing the largest quantity of the type of item.

The actual volume determination unit is configured to determine a volume value of the item according to the historical maximum storage quantity of the type of item and the effective space volume of accommodation in the location storing the largest quantity of the type of item, and use the estimated volume of the type of item as the actual volume of the type of item.

In an embodiment, the above device can further include a basic volume determination module and an actual volume determination module.

The basic volume determination module is configured to determine a basic volume value of the type of item.

The actual volume determination module is further configured to compare the volume value of the item with the basic volume value of the type of item, and in the case of inconsistency, update the basic volume value of the type of item according to the estimated volume of the type of item.

In an embodiment, the location volume determination unit is configured to: determine an effective volume of accommodation in the location storing the largest quantity of the type of item according to the volume of accommodation in the location storing the largest quantity of the type of item and a preset threshold of an effective space utilization rate of the location.

In an embodiment, the basic volume determination module is configured to: receive volume field information of the type of item, and initialize a basic volume value of the type of item according to the volume field information; or based on the type, acquire an average volume value of this type from an item statistics table, and initialize a basic volume value of the type of item according to the average volume value of the type.

### Embodiment V

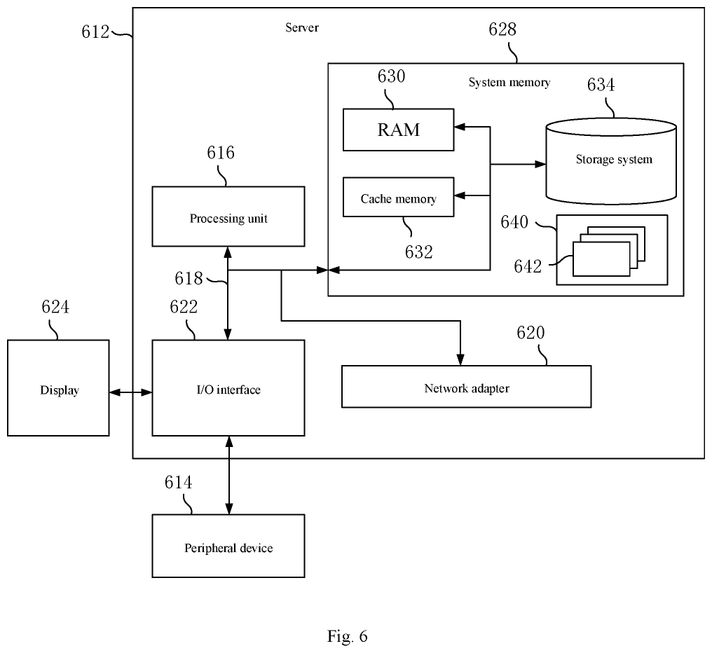

FIG. 6 is a schematic structural diagram of a server provided in Embodiment V of the present application. FIG. 6 shows a block diagram of an exemplary server 612 adapted to implement embodiments of the present application. The server 612 shown in FIG. 6 is only an example, and has no limitation on the functions and scope of use of the embodiments of the present application.

As shown in FIG. 6, the server 612 is embodied in the form of a general-purpose computing device. Components of the server 612 can include, but are not limited to, one or more processors or processing units 616, a system memory 628, and a bus 618 connecting different system components (including the system memory 628 and the processing unit 616).

The bus 618 represents one or more of several types of bus structures, including a memory bus or memory controller, a peripheral bus, an accelerated graphics port, a processor, or a local bus using any of multiple types of bus structures. For example, these architectures include, but are not limited to, an industry standard architecture (ISA) bus, a micro channel architecture (MAC) bus, an enhanced ISA bus, a video electronics standards association (VESA) local bus and a peripheral component interconnect (PCI) bus.

The server 612 typically includes multiple types of computer system readable media. These media can be any available media that can be accessed by the server 612, including volatile and non-volatile media, removable and non-removable media.

The system memory 628 can include a computer system readable medium in the form of a volatile memory, such as a random access memory (RAM) 630 and/or a cache memory 632. The server 612 can further include other removable/non-removable, volatile/nonvolatile computer system storage media. Only as an example, a storage system 634 can be used to read from and write to a non-removable, non-volatile magnetic medium (not shown in FIG. 6, generally referred to as a “hard drive”). Although not shown in FIG. 6, a magnetic disc drive for reading from and writing to a removable non-volatile magnetic disc (such as a “floppy disc”) and an optical disc drive for reading from and writing to a removable non-volatile optical disc (such as a compact disc read-only memory (CD-ROM), a DVD-ROM or other optical medium) can be provided. In these cases, each drive can be connected to the bus 618 through one or more data medium interfaces. The system memory 628 can comprise at least one program product having a set of (for example, at least one) program modules, which are configured to perform functions of the embodiments of the present application.

A program/utility tool 640 having a set of (at least one) program modules 642 can be stored in, for example, the system memory 628. Such program modules 642 include, but are not limited to, an operating system, one or more application programs, other program module(s) and program data. Each or some combination of the examples may include an implementation of a network environment. The program modules 642 generally perform functions and/or methods in the embodiments described in this application.

The server 612 may also communicate with one or more peripheral devices 614 (such as a keyboard, a pointing device, a display 624, etc.), and may also communicate with one or more devices that enable a user to interact with the server, and/or communicate with any device (such as a network card, a modem, etc.) that enables the server 612 to communicate with one or more other computing devices. Such communication can be performed through an input/output (I/O) interface 622. In addition, the server 612 may also communicate with one or more networks (such as a local area network (LAN), a wide area network (WAN), and/or a public network such as the Internet) through a network adapter 620. As shown, the network adapter 620 communicates with other modules of the server 612 through the bus 618. It should be understood that although not shown in the figure, other hardware and/or software modules can be used in conjunction with the server 612, including but not limited to a microcode, a device driver, a redundant processing unit, an external disc drive array, and a redundant arrays of independent disks (RAID) system, a magnetic tape drive, and a data backup storage system.

The processing unit 616 runs a program stored in the system memory 628 to execute various functional applications and data processing, for example, implementing an order processing method provided in the embodiment of the present application.

### Embodiment VI

Embodiment VI of the present application further provides a computer-readable storage medium storing a computer program that, when executed by a processor, can implement any of the order processing methods in the foregoing embodiments.

The computer storage medium in the present application can be any combination of one or more computer-readable media. The computer-readable medium can be a computer-readable signal medium or a computer-readable storage medium. The computer-readable storage medium can be, for example, but not limited to, an electronic, magnetic, optical, electromagnetic, infrared, or semiconductor system, apparatus or device, or any combination thereof. More specific examples (a non-exhaustive list) of the computer-readable storage medium include: an electrical connection with one or more conducting wires, a portable computer disc, a hard disc, an random access memory (RAM), a read only memory (ROM), an erasable programmable read only memory (EPROM) or flash memory, an optical fiber, a portable compact disk-read only memory (CD-ROM), an optical storage device, a magnetic storage device, or any suitable combination thereof. As used herein, a computer-readable storage medium can be any tangible medium that contains or stores a program that can be used by or in combination with an instruction execution system, device or device.

The computer-readable signal medium can include a data signal propagated in a baseband or as part of a carrier wave, and the data signal carries computer-readable program codes. Such a propagated data signal can take many forms, including but not limited to an electromagnetic signal, an optical signal, or any suitable combination thereof. The computer-readable signal medium may also be any computer-readable medium other than a computer-readable storage medium, and the computer-readable medium can send, propagate or transmit a program for use by or in connection with an instruction execution system, apparatus or device.

The program codes included in the computer-readable medium can be transmitted by using any appropriate medium, including but not limited to a wireless, wire, optical cable, or radio frequency (RF) medium, or any suitable combination thereof.

The computer program codes for performing the operations of the present application can be written in one or more programming languages or a combination thereof, the programming languages including an object-oriented programming language such as Java, Smalltalk, or C ++, and also including a conventional procedural programming language, such as “C” or similar programming language. The program codes can be executed entirely on a user's computer, partly on a user's computer, as an independent software package, partly on a user's computer and partly on a remote computer, or entirely on a remote computer or server. In the case where a remote computer is involved, the remote computer can be connected to a user's computer through any type of network, including an local area network (LAN) or wide area network (WAN), or it can be connected to an external computer (such as being connected through the Internet from an Internet service provider).

In the above embodiment, the exemplary illustrative scheme for determining a basic volume value of the type of item includes: when detecting that a new stacking operation of the type of item is completed, searching for a stacking location set involved in the new stacking operation; for each stacking location in the stacking location set, determining an upper limit of current unit volume for the type of item in the stacking location according to a location volume of the stacking location and a storage quantity of the type of item in the stacking location; and updating a basic volume value of the type of item according to the corresponding upper limit of current unit volume for the type of item on each stacking location.

### Embodiment VII

FIG. 8 is a schematic flow diagram of an item volume estimation method provided in Embodiment VII of the present application. The item volume estimation method in the embodiment of the present application can be applied to a scenario in which the volume of an item on a shelf is maintained in real time. The method can be executed by a device for calculating the volume of an item. The device can be embodied in at least one of software and hardware. The device can be integrated in any computer device for calculating the volume of an item, having a network communication function. As shown in FIG. 8, the item volume estimation method in the embodiment of the present application can comprise steps 801, 802 and 803.

Step 801: searching for a stacking location set involved in the new stacking operation when detecting that a new stacking operation of a current SKU item is completed. The “stacking location set” in this embodiment is also called “location set”.

In the embodiment of the present application, items in a warehouse can be stored on locations of shelves. For example, the items of the same type can be stored on the same location of the same shelf in a distributed manner, different locations of the same shelf in a distributed manner, or different locations of different shelves in a distributed manner. To better manage various commodities stored on the locations of the shelves, corresponding SKU codes can be created for the various commodities stored on the locations of the shelves. Each type of item can correspond to a unique SKU code. The SKU code can be understood as a unified number or a unique identification number of the item, and various items can be identified by corresponding SKU codes. A new stacking operation of a current SKU item can be understood as that in addition to the current SKU items pre-stored on shelf locations, there are new items with the same SKU as the current SKU items stored on shelf locations in the warehouse; or it can also be understood as that among the current SKU items pre-stored on shelf locations, some items are re-stored, from the shelf locations for pre-storage, to locations of other shelves in the warehouse. For example, an item with SKU1 is stored in locations in a warehouse, when additional items with SKU1 are stored on one or more locations in the warehouse, it can be understood as a new stacking operation of the item with SKU1, and the newly added items have the same SKU, i.e. having SKU1. Of course, not all of the locations are newly added with the item with SKU1, and one or more can be selected from the locations in the warehouse to store the item, that is, searching for a stacking location involved in the new stacking operation.

In the embodiment of the present application, when the new stacking operation is completed, the newly stacked item with the same SKU may be stored on the same location of the same shelf in a concentrated manner, or may be stored on different locations of the same shelf in a distributed manner, or may also be stored on different locations of different shelves in a distributed manner. In addition, when the newly added items are stored on different locations, only some locations of some shelves may be involved. Based on the above situation, when it is detected that a new stacking operation of a current SKU item is completed, a stacking location set involved in the stacking operation can be searched for. The stacking location set can include one or more stacking locations. The stacking location set involved in the stacking operation can be understood as, when a new stacking operation of a current SKU item is completed, a stacking location set used when the newly added item with the current SKU is stacked and stored.

In an embodiment, using a warehouse with a first shelf, a second shelf and a third shelf as an example. The first shelf can include a location G11, a location G12, and a location G13; the second shelf can include a location G21, a location G22, and a location G23; and the third shelf can include a location G31, a location G32, and a location G33. An item A with the current SKU1 is stored on locations G11, G22 and G33. When it is detected that a new stacking operation of the item A is completed, it may indicate that in addition to the items A pre-stored on the locations G11, G22 and G33, there are new item A stored on one or more locations of the shelf 1, shelf 2 or shelf 3; and/or it may also indicate that among the items A on the locations G11, G22 and G33, one or more of the items A are re-stored, from the locations G11, G22 and G33, to locations of other shelves in the warehouse; and/or it may also indicate that among the items A on the good locations G11, G22 and G33, one or more of the items A are exchanged between the locations G11, G22 and G33. In the above cases, the locations in the warehouse used when the new item A are stored, and the locations used to which the items A are exchanged from the pre-storing locations G11, G22 or G33 for re-storage, both can be understood as a stacking location set involved in the stacking operation of the item A.

In the embodiment of the present application, after an item is stored on locations of shelves, the item and location information mapping table can be generated between item information (including but not limited to an SKU code of the item) and location information of the location used when the item is stored. By using the item and location information mapping table, on any location of any shelf, item information corresponding to location information of the shelf can be searched for. Based on any item information, location information of the locations used when the item is stored may also be searched for. SKU item that undergoes a new stacking operation completion event, and location information of location used for the SKU item when a new stacking operation is completed can be determined according to the item and location information mapping table. In an embodiment, when it is detected that a new stacking operation of a current SKU item is completed, a stacking location set involved in the stacking operation can be searched for in an item and location information mapping table based on the current SKU. The item and location information mapping table can include a mapping relationship between the item information corresponding to each item and the location information of the location used when each item is stored.

Step 802: for each stacking location in the stacking location set, determining a current upper limit of unit volume of the current SKU item in the stacking location according to a location volume of the stacking location and a storage quantity of the current SKU item in the stacking location.

In the embodiment of the present application, the current upper limit of unit volume can be understood as an upper limit of a location space volume of the shelf that can be occupied when a single item with the current SKU is used on the stacking location. When a corresponding current upper limit of unit volume is determined, it can be understood as that a corresponding current upper limit of unit volume is calculated according to the inventory on the stacking location. In simple terms, the current upper limit of unit volume can be a ratio between a location volume of the stacking location and the quantity of items of the current SKU item stored on the stacking location. In addition, not only the current SKU item but also other SKU items can be stored on the stacking location. Therefore, an actual total volume of the current SKU item stored on the stacking location (a sum of true volumes of the items of the current SKU item) is smaller than the location volume of the stacking location. The corresponding current upper limit of unit volume determined according to the location volume of the stacking location and the quantity of the current SKU item on the stacking location is actually greater than a true volume of the current SKU item. In addition, as factors such as the shape of the current SKU item, that whether or not it can be squeezed, or the stacking manner can influence the volume of space occupied when the current SKU item is stored on the stacking location, thus the volume of space occupied when the current SKU item is stored on the stacking location is smaller than the three-dimensional volume of the current SKU item when it is not stored on the stacking location. For example, the current SKU item is stored after being squeezed on the stacking location. In this case, the volume of space actually occupied by the current SKU item on the stacking location is smaller than the three-dimensional volume of the item in the space.

In an embodiment, using a stacking location including a first shelf, a second shelf and a third shelf as an example. Assuming that location volumes of stacking locations such as the locations G11, G22 and G33 are all set to V, and the quantity of the items A with the current SKU1 stored on G11 is 10, the quantity of the items A stored on G22 is 30, and the quantity of items A stored on G33 is 100. In this case, a current upper limit of unit volume of the item A on the location G11 is V/10, a current upper limit of unit volume of the item A on the location G22 location is V/30, and a current upper limit of unit volume of the item A on the location G33 is V/100. It should be noted that V/10, V/30 and V/100 are actually larger than the true volume of the current SKU item. It can be understood that locations on shelves may have the same location volume, or may also have different location volume.

In the embodiment of the present application, only when the quantity of the current SKU item stored on the stacking location is as large as possible, for example, only the current SKU items are stored on the stacking location, and the stacking location is full of the current SKU items as much as possible, can the actual total volume of the current SKU item stored on the stacking location gradually approximate the location volume of the stacking location. As such, the current upper limit of unit volume determined according to the location volume of the stacking location and the quantity of the current SKU item stored on the stacking location gradually approximates the true volume of the current SKU item. In addition, considering that in actual scenarios, the stacking location cannot be filled with the current SKU item to full, and there are no gaps in the stacking location, thus no matter how the current upper limit of unit volume approximates the true volume of the current SKU item, the current upper limit of unit volume is always larger than the true volume of the current SKU item.

In the embodiment of the present application, when there is a new stacking operation of the current SKU item, the newly stacked current SKU item may be stored on different locations in a distributed manner. Therefore, in determination of a current upper limit of unit volume of the current SKU item on the stacking location, it needs to determine, for each stacking location in the stacking location set, a current upper limit of unit volume of the current SKU item on the stacking location according to the location volume of the stacking location and the quantity of the current SKU item on the stacking location. In addition, to calculate the current upper limit of unit volume, a total quantity of the current SKU item stored on the stacking location, and the location volume of the stacking location can be acquired first.

In an optional implementation of the embodiment of the present application, determining a current upper limit of unit volume of the current SKU item in the location according to a location volume of accommodation in the location and a storage quantity of the current SKU item in the location can include steps 802a and 802b.

Step 802a: determining a filling rate of the stacking location when the current SKU item uses the location.

Step 802b: determining a current upper limit of unit volume of the current SKU item on the location according to a location volume of accommodation in the location, a storage quantity of the current SKU item in the location, and the filling rate of the location, where the current upper limit of unit volume is greater than a true volume of the current SKU item.

The “filling rate” in the embodiment of the present application is also called “effective space utilization rate”.

In this implementation, in general, for reasons such as preventing the item from falling from the stacking location, great difficulty in filling the innermost layer of the stacking location with the item, and the presence of gaps between items placed on the stacking location, it is impossible to fill the stacking location with the item to 100%. As such, the location volume of the stacking location cannot be fully used, which results in that the current upper limit of unit volume determined only based on the location volume of the stacking location and the quantity of the current SKU item on the stacking location cannot well approximate the true volume of the current SKU item. Thus, in determination of the current upper limit of unit volume of the current SKU item on the stacking location, the location volume of the stacking location needs to be discounted. Based on the above situation, this embodiment introduces a filling rate of the stacking location used for the current SKU item. In determination of the current upper limit of unit volume of the current SKU item on the stacking location, not only the location volume of the stacking location and the quantity of the current SKU item on the stacking location, but also the filling rate of the stacking location used for the current SKU item are considered, so that the calculated current upper limit of unit volume of the current SKU item on the stacking location is more approximate to the true volume of the current SKU item. The filling rate of the stacking location is less than or equal to 1, and the filling rate of the stacking location can be determined according to an association relationship between the shape of the item placed on the stacking location and actual structural features of the stacking location. The higher matched degree of the shape of the item placed on the stacking location and actual structural features of the stacking location is high, the more items can be placed on the stacking location, and the filling rate of the stacking location can be set higher; otherwise, the filling rate of the stacking location is set lower.

In this implementation, for example, using a location 33 included in a stacking location set as an example. The location volume of accommodation in the location 33 is set to V, and the quantity of the current SKU item stored on the location 33 is N, and the filling rate of the location 33 used for the current SKU item are R. In this case, the current upper limit of unit volume of the current SKU item on the stacking location can be calculated according to the formula: the current upper limit of unit volume=(the location volume of the stacking location V)·(the filling rate of the stacking location R)/(the quantity of the current SKU item stored on the stacking location N), where the current upper limit of unit volume is greater than the true volume of the current SKU item, and the filling rate R of the stacking location is less than or equal to 1.

Step 803: updating a historical volume of the current SKU item according to the corresponding current upper limit of unit volume of the current SKU item on each stacking location.

The “historical volume of the current SKU item” is also the “basic volume value of the type of item” in the foregoing embodiments.

In the embodiment of the present application, both the current upper limit of unit volume of the current SKU item on each stacking location and the historical volume of the current SKU item are greater than the true volume of the current SKU item. Thus, a core idea of the method for determining the volume of an item in this embodiment is determining which of the current upper limit of unit volume of the current SKU item on each stacking location and the historical volume of the current SKU item are more approximate to the true volume of the current SKU item. In other words, if the current upper limit of unit volume of the current SKU item on the stacking location is more approximate to the historical volume of the current SKU item, then the current upper limit of unit volume of the current SKU item on the stacking location is used as the true volume of the current SKU item. The historical volume of the current SKU item can be understood as already determined for the current SKU item before a new stacking operation of the new SKU item is completed. The historical volume of the current SKU item is a calculated value and can be constantly updated with the quantity of the current SKU item stored on the stacking location.

The method for determining the volume of an item provided in the embodiment of the present application includes: when detecting that a new stacking operation of a current SKU item is completed, searching, based on the current SKU, for a stacking location set involved in the stacking operation; for each stacking location in the stacking location set, determining a current upper limit of unit volume of the current SKU item in the stacking location according to a location volume of the stacking location and the quantity of the current SKU item in the stacking location; and updating a historical volume of the current SKU item according to the current upper limit of unit volume of the current SKU item on each stacking location. The technical solution of the embodiment of the present application not only can achieve the maintenance of a relatively accurate item volume for each SKU item in the warehouse; compared with an actually measured item volume, the item volume calculated in this solution of the embodiment can better reflect the space occupied by the item, and this can also reduce equipment costs and labor costs.

### Embodiment VIII

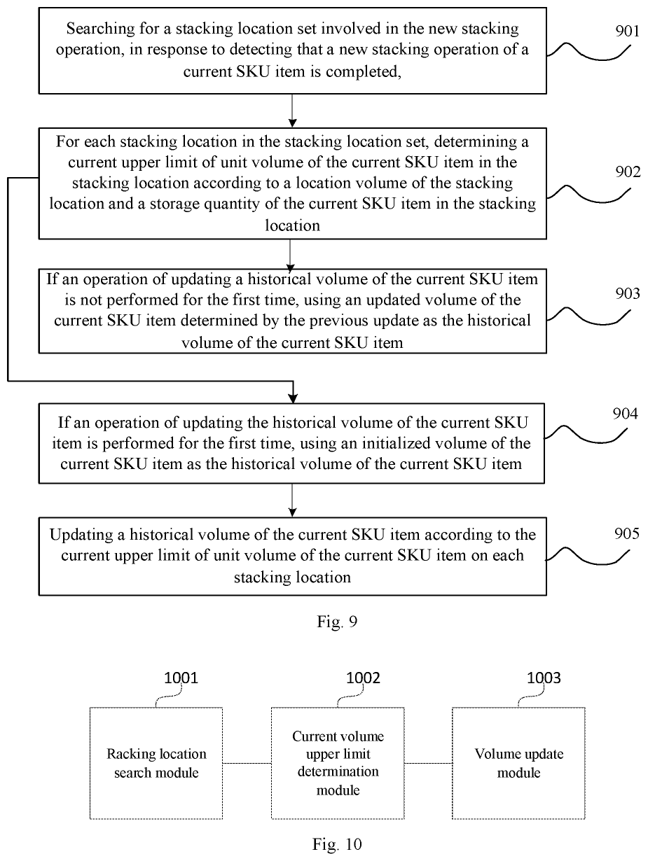

FIG. 9 is a schematic flow diagram of a schematic flow diagram of a method for determining the volume of an item provided in Embodiment VIII of the present application.

As shown in FIG. 9, the item volume estimation method in the embodiment of the present application can include steps 901 to 905.

Step 901: searching for a stacking location set involved in the new stacking operation, in response to detecting that a new stacking operation of a current SKU item is completed.

In the item volume estimation method in the embodiment of the present application, a current upper limit of unit volume of the current SKU item on a stacking location is calculated based on the quantity of the current SKU items stored on the stacking location, so as to calculate a true volume of the current SKU item according to the current upper limit of unit volume. In response to determining that a new stacking operation of the current SKU item is completed, if the quantity of the current SKU item stored on the stacking location is less than the quantity of the current SKU item historically stored on the stacking location, a current upper limit of unit volume of the current SKU item on the stacking location can be calculated to be greater than a historical upper limit of unit volume of the current SKU item on the stacking location. In this case, compared with the current upper limit of unit volume, the historical upper limit of unit volume is more approximate to the true volume of the current SKU item, and the corresponding calculated current upper limit of unit volume is invalid, so a step of determining the current unit volume limit of the current SKU item on the stacking location is also invalid. Based on the above situation, each stacking location in the stacking location set may also meet a condition that the quantity of the current SKU item currently stored on the stacking location is greater than the quantity of the current SKU item historically stored on the stacking location.

Step 902: for each stacking location in the stacking location set, determining a current upper limit of unit volume of the current SKU item on the stacking location according to a location volume of the stacking location and a storage quantity of the current SKU item on the stacking location.

In an implementation of the embodiment of the present application, determining a current upper limit of unit volume of the current SKU item on the stacking location according to a location volume of the stacking location and a storage quantity of the current SKU item on the stacking location can include:
determining a filling rate of the stacking location when the current SKU item uses the stacking location; and
calculating a current upper limit of unit volume of the current SKU item on the stacking location according to a location volume of the stacking location a storage quantity of the current SKU item on the stacking location and the filling rate of the stacking location, where the current upper limit of unit volume is greater than the true volume of the current SKU item.

Step 903: if an operation of updating a historical volume of the current SKU item is not performed for the first time, using an updated volume of the current SKU item determined by the previous update as the historical volume of the current SKU item.

In the embodiment of the present application, that an operation of updating a historical volume of the current SKU item is not performed for the first time can be understood as that the historical volume of the current SKU item has been updated before and the updated volume of the current SKU item obtained last time is used as the historical volume of the current SKU item.

Step 904: if an operation of updating the historical volume of the current SKU item is performed for the first time, using an initialized volume of the current SKU item as the historical volume of the current SKU item.

In the embodiment of the present application, the operation of updating the historical volume of the current SKU item can be understood as that the historical volume of the current SKU item has not been updated before. As the operation of updating the historical volume of the current SKU item is performed for the first time, the historical volume of the current SKU item is not clear. Thus, an initialized volume of the current SKU item can be acquired directly, and the acquired initialized volume of the current SKU item as the historical volume of the current SKU item. In general, the initialized volume of the current SKU item is used only when the historical volume of the current SKU item is updated for the first time. When the historical volume of the current SKU item is not updated for the first time, the updated volume obtained by updating the historical volume of the current SKU item last time can be used as the latest historical volume of the current SKU item.

In an implementation of the embodiment of the present application, acquiring an initialized volume of the current SKU item can include steps 904a, 904b and 904c.

Step 904a: based on the current SKU, searching, from historical inventory data, for a historical location set involved when the current SKU item was historically stored.

Step 904b: for each historical location in the historical location set, determining a historical upper limit of unit volume of the current SKU item on the historical location according to a historical location volume of the historical location and a storage quantity of the current SKU item on the historical location.

Step 904c: selecting, from historical upper limits of unit volume of the current SKU item in each historical location, a historical upper limit of unit volume that meets a third preset criterion as an initialized volume of the current SKU item.

In this implementation, the historical location set involved when the current SKU item was historically stored may be recorded in the historical inventory data. The historical location sets can be found from the historical inventory data based on the current SKU. Then, for each historical location in the historical location set, a historical upper limit of unit volume of the current SKU item on the historical location can be determined according to a historical location volume of the historical location and the quantity of the current SKU item on the historical location. In an embodiment, determining a historical upper limit of unit volume of the current SKU item on the historical location according to a historical location volume of the historical location and the quantity of the current SKU item on the historical location can include: determining a filling rate of the stacking location used for the current SKU item; and determining a historical upper limit of unit volume of the current SKU item on the historical location according to a historical location volume of the historical location, the quantity of the current SKU item on the historical location, and the filling rate of the historical location, where the historical upper limit of unit volume is greater than the true volume of the current SKU item. It should be noted that the process of determining a historical upper limit of unit volume in this implementation is similar to the process of determining a current upper limit of unit volume, except that one relates to a current upper limit of unit volume in a current state, and the other relates to a historical upper limit of unit volume calculated after corresponding data are acquired from historical inventory data. For specific related explanation, reference can be made to the explanation of determining the current unit volume.

In this implementation, although the historical upper limit of unit volume with the current SKU on each historical location in the historical location set is obtained as described above, it cannot ensure that all historical upper limit of unit volumes are valid, so it needs to select an optimal historical upper limit of unit volume from multiple historical upper limits of unit volume. To ensure that the initialized volume of the current SKU item are more approximate to the true volume of the current SKU item, the smallest historical upper limit of unit volume can be selected from determined multiple historical upper limits of unit volume as the initialized volume of the current SKU item. The third preset criterion may be a historical upper limit of unit volume with the smallest volume upper limit value among the multiple historical upper limits of unit volume.

Step 905: updating a historical volume of the current SKU item according to the current upper limit of unit volume of the current SKU item on each stacking location.

In an implementation of the embodiment of the present application, updating a historical volume of the current SKU item according to the corresponding current upper limit of unit volume of the current SKU item on each stacking location can include a sub-process composed of the following steps 9051a and 9051b (not shown in the figure).

Step 9051a: selecting a current upper limit of unit volume that meets a first preset criterion from current upper limits of unit volume of the current SKU item on each location.

Step 9051b: if the current upper limit of unit volume that meets the first preset criterion is smaller than a historical volume of the current SKU item, using the current upper limit of unit volume that meets the first preset criterion as an updated volume of the current SKU item.

In this implementation, after a current upper limit of unit volume of the current SKU item on each stacking location, multiple current upper limits of unit volume obtained can be sorted in the order of from large to small upper limit of unit volume values, and a current upper limit of unit volume with the smallest upper limit of unit volume value is selected from the sorted multiple current upper limit of unit volumes as the current upper limit of unit volume that meets the first preset criterion. The first preset criterion can be understood as a current upper limit of unit volume with the smallest volume upper limit value among multiple current upper limit of unit volumes.

In this implementation, after the current upper limit of unit volume of the current SKU item that meets the first preset criterion is selected, it needs to compare the current upper limit of unit volume of the current SKU item that meets the first preset criterion with a historical volume of the current SKU item, determine which volume is most approximate to the true volume of the current SKU item, and use the most approximate one as an updated volume of the current SKU item, to implement an update operation of the historical volume. If the current upper limit of unit volume of the current SKU item that meets the first preset criterion is smaller than the historical volume of the current SKU item, the current upper limit of unit volume of the current SKU item that meets the first preset criterion is used as an updated volume of the current SKU item; and if the current upper limit of unit volume of the current SKU item that meets the first preset criterion is greater than or equal to the historical volume of the current SKU item, the historical volume of the current SKU item is not updated, and the historical volume of the current SKU item is still used as an updated volume of the current SKU item.

In another implementation of the embodiment of the present application, updating a historical volume of the current SKU item according to the corresponding current upper limit of unit volume of the current SKU item on each stacking location can include a sub-process composed of the following steps 9052a, 9052b and 9052c (not shown in the figure).

Step 9052a: for a current unit volume limit of the current SKU item in each location, determining whether the current unit volume limit in the stacking location is smaller than a historical volume of the current SKU item.

Step 9052b: in response to determining that the current upper limit of unit volume in the stacking location is smaller than the historical volume of the current SKU item, using the current upper limit of unit volume of the current SKU item in the stacking location as a candidate volume.

Step 9052c: in response to determining that there is at least one candidate volume, selecting from the at least one candidate volume a candidate volume that meets a second preset criterion as an updated volume of the current SKU item.

In this implementation, after multiple current upper limits of unit volume are determined, it needs to determine which one of the multiple current upper limits of unit volume are more approximate to the true volume of the current SKU item than the historical volume of the current SKU item. For example, for the current upper limit of unit volume of the current SKU item on each stacking location, it is determined whether the current upper limit of unit volume on the stacking location is smaller than the historical volume of the current SKU item. If the current upper limit of unit volume of the current SKU item on the stacking location is smaller than the historical volume of the current SKU item, it indicates that the current upper limit of unit volume of the current SKU item on the stacking location is more approximate to the true volume of the current SKU item; and if the current upper limit of unit volume of the current SKU item on the stacking location is greater than the historical volume of the current SKU item, it indicates that the historical volume of the current SKU item is more approximate to the true volume of the current SKU item.

In this implementation, although each current upper limit of unit volume in the candidate volume(s) is more approximate to the true volume of the current SKU item than the historical volume of the current SKU item, in order to select a current upper limit of unit volume most approximate to the true volume of the current SKU item from the candidate volume(s), the smallest candidate volume can be selected from the at least one candidate volume as an updated volume of the current SKU item. It should be noted that the two specific optional implementations of updating the historical volume of the current SKU item in the above step 905 may be used separately or in combination.

It should be noted that the basic idea of the method for determining the volume of an item in the embodiment of the present application is calculating a current upper limit of unit volume of the current SKU item on a stacking location based on the quantity of the current SKU item on the stacking location, and then updating a historical volume of the current SKU item according to the current upper limit of unit volume. The reason why the aforementioned current unit volume limit is used is that three-dimensional data of an item is not the only factor that determines the volume occupied by the item. Other similar factors such as the shape of the item, whether or not the item can be squeezed, and the placing manner can influence the volume occupied by the item. These factors can be fully considered in the current upper limit of unit volume of the item, so that a true volume occupied by the item can be obtained more accurately based on the current upper limit of unit volume. Moreover, the technical solution of this embodiment is implemented fully automatically, which does not require expensive measuring equipment or man hours, so that equipment costs and labor costs for determining the item volume are greatly reduced.

In the method for determining the volume of an item provided in the embodiment of the present application, actual stacking data can be automatically acquired and a historical volume of the item can be updated in real time based on the data, so that an updated volume of the item are increasingly approximate to a true volume occupied by the item. Moreover, compared with an actually measured item volume, the item volume calculated according to the solution of the embodiment can better reflect the space occupation of the item, and can also reduce equipment costs and labor costs.

### Embodiment IX

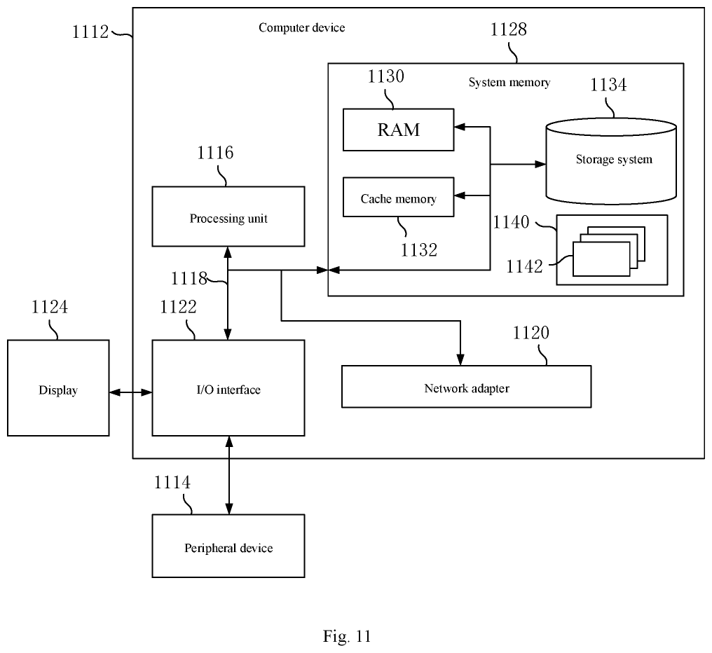

FIG. 10 is a schematic structural diagram of a device for determining goods volume provided in Embodiment IX of the present application. The device executes the method for determining the volume of an item provided in the foregoing embodiments. The device can be embodied in at least one of software and hardware. The device can be integrated in any computer device for determining the volume of an item, having a network communication function.

As shown in FIG. 10, the device for determining the goods volume in the embodiment of the present application can include a stacking location search module 1001, a current volume upper limit determination module 1002, and a volume update module 1003.

The stacking location search module 1001 is configured to, in response to detecting that a new stacking operation of a current SKU item are completed, search for a stacking location set involved in the new stacking operation.

The current volume upper limit determination module 1002 is configured to, for each stacking location in the stacking location set, determine a current upper limit of unit volume of the current SKU item in the location according to a location volume of the stacking location and a storage quantity of the current SKU item in the stacking location.

The volume update module 1003 is configured to update a historical volume of the current SKU item according to the current upper limit of unit volume of the current SKU item in each stacking location.

The “historical volume of the item having the current SKU” is the “basic volume value of the type of item” in the foregoing embodiments.

In an exemplary implementation of the embodiment of the present application, the current volume upper limit determination module 1002 can include a filling rate determination unit and a current volume upper limit determination unit.

The filling rate determining unit is configured to determine a filling rate of the stacking location when the current SKU item uses the stacking location.

The current volume upper limit determination unit is configured to determine a current upper limit of unit volume of the current SKU item in the stacking location according to a location volume of the stacking location, a storage quantity of the current SKU item in the location, and the filling rate of the stacking location, where the current upper limit of unit volume is greater than a true volume of the current SKU item.

In an exemplary implementation of the embodiment of the present application, the volume update module 1003 can include a first acquisition unit, a second acquisition unit and a volume update unit.

The first acquisition unit is configured to, if an operation of updating the historical volume of the current SKU item is not performed for the first time, acquire an updated volume of the current SKU item determined by the previous update as the historical volume of the current SKU item.

The second acquisition unit is configured to, if an operation of updating the historical volume of the current SKU item is performed for the first time, acquire an initialized volume of the current SKU item as the historical volume of the current SKU item.

The volume update unit is configured to update a historical volume of the item having the current SKU according to the current upper limit of unit volume of the item having the current SKU on each stacking location.

In an exemplary implementation of the embodiment of the present application, the volume update unit can include a first selection subunit and a first update subunit.

The first selection subunit is configured to select a current upper limit of unit volume that meets a first preset criterion from current upper limits of unit volume of the current SKU item in each stacking location.

The first update subunit is configured to, if the current upper limit of unit volume that meets the first preset criterion is smaller than a historical volume of the current SKU item, use the current upper limit of unit volume that meets the first preset criterion as an updated volume of the current SKU item.

In another exemplary implementation of the embodiment of the present application, the volume update unit can include a determination subunit, a candidate subunit and a second update subunit.

The determination subunit is configured to determine, for a current unit volume limit of the current SKU item in each stacking location, determine whether the current unit volume limit of the current SKU item in the stacking location is smaller than a historical volume of the current SKU item.

The candidate subunit is configured to, if the current upper limit of unit volume of the current SKU item in the stacking location is smaller than the historical volume of the current SKU item, use the current upper limit of unit volume of the current SKU item in the stacking location as a candidate volume.

The second update subunit configured to, if there is at least one candidate volume, select from the at least one candidate volume a candidate volume that meets a second preset criterion as an updated volume of the current SKU item.

In an exemplary implementation of the embodiment of the present application, the second acquisition unit can include a historical location search subunit, a historical volume upper limit determination subunit and an initialized volume determination unit.

The historical location search subunit is configured to, based on the current SKU, search, from historical inventory data, for a historical location set involved when the current SKU item was historically stored.

The historical volume upper limit determination subunit is configured to, for each historical location in the historical location set, determine a corresponding historical upper limit of unit volume of the current SKU item on the historical location according to a historical location volume of the historical location and a storage quantity of the current SKU item in the historical location.

The initialized volume determination unit is configured to select, from historical upper limits of unit volume of the current SKU item in each historical location, a historical upper limit of unit volume that meets a third preset criterion as an initialized volume of the current SKU item.

The device for determining goods volume provided in the embodiment of the present application can execute the method for determining goods volume provided in any embodiment of the present application, and has corresponding functional modules and beneficial effects for executing the method for determining goods volume.

### Embodiment X

FIG. 11 is a schematic structural diagram of a computer device provided in Embodiment X of the present invention. FIG. 11 shows a block diagram of an exemplary computer device 1112 adapted to implement embodiments of the present invention. The computer device 1112 shown in FIG. 11 is only an example, and has no limitation on the functions and scope of use of the embodiments of the present invention.

As shown in FIG. 11, the computer device 1112 is embodied in the form of a general-purpose computing device. The components of the computer device 1112 can include, but are not limited to, one or more processors or processing units 1116, a system memory 1128, and a bus 1118 connecting different system components (including the system memory 1128 and the processing unit 1116).

The bus 1118 represents one or more of several types of bus structures, including a memory bus or memory controller, a peripheral bus, an accelerated graphics port, a processor, or a local bus using any of multiple types of bus structures. For example, these architectures comprise, but are not limited to, an industry standard architecture (ISA) bus, a micro channel architecture (MAC) bus, an enhanced ISA bus, a video electronics standards association (VESA) local bus and a peripheral component interconnect (PCI) bus.

The computer device 1112 typically includes multiple types of computer system readable media. These media can be any available media that can be accessed by the computer device 1112, including volatile and non-volatile media, removable and non-removable media.

The system memory 1128 can include a computer system readable medium in the form of a volatile memory, such as a random access memory (RAM) 1130 and/or a cache memory 1132. The order supply and demand scheduling computer device 1112 can further comprise other removable/non-removable, volatile/nonvolatile computer system storage media. Only as an example, a storage system 1134 can be used to read from and write from a non-removable, non-volatile magnetic medium (not shown in FIG. 11, generally referred to as a “hard drive”). Although not shown in FIG. 11, a magnetic disc drive for reading from and writing to a removable non-volatile magnetic disc (such as a “floppy disc”) and an optical disc drive for reading from and writing to a removable non-volatile optical disc (such as a CD-ROM, a DVD-ROM or other optical medium) can be provided. In these cases, each drive can be connected to the bus 1118 through one or more data medium interfaces. The system memory 1128 can comprise at least one program product having a set of (for example, at least one) program modules, which are configured to perform functions of the embodiments of the present invention.

A program/utility tool 1140 having a set of (at least one) program modules 1142 can be stored in, for example, the memory 1128. Such program modules 1142 include, but are not limited to, an operating system, one or more application programs, other program module(s) and program data. Each or some combination of the examples may include an implementation of a network environment. The program modules 1142 generally perform functions and/or methods in the embodiments described in the present invention.

The computer device 1112 may also communicate with one or more peripheral devices 1114 (such as a keyboard, a pointing device, a display 1124, etc.), and may also communicate with one or more devices that enable a user to interact with the computer device 1112, and/or communicate with any device (such as a network card, a modem, etc.) that enables the computer device 1112 to communicate with one or more other computing devices. Such communication can be performed through an input/output (I/O) interface 1122. Moreover, the computer device 1112 may also communicate with one or more networks (such as a local area network (LAN), a wide area network (WAN), and/or a public network such as the Internet) through a network adapter 1120. As shown in FIG. 11, the network adapter 1120 communicates with other modules of the computer device 1112 through the bus 1118. It should be understood that although not shown in the FIG. 11, other hardware and/or software modules can be used in conjunction with the computer device 1112, including but not limited to a microcode, a device driver, a redundant processing unit, an external disc drive array, and a RAID system, a magnetic tape drive, and a data backup storage system.

By running a program stored in the system memory 1128, the processing unit 1116 executes various functional applications and data processing, for example, implementing a method for determining goods volume provided in an embodiment of the present invention, the method including:
in response to detecting that a new stacking operation of a current SKU item is completed, searching for a stacking location set involved in the new stacking operation;
for each stacking location in the stacking location set, determining a current upper limit of unit volume of the current SKU item in the stacking location according to a location volume of the stacking location and a storage quantity of the current SKU item in the stacking location; and
updating a historical volume of the current SKU item according to the current upper limit of unit volume of the current SKU item on each stacking location.

### Embodiment XI

Embodiment XI of the present invention further provides a computer-readable storage medium storing a computer program that, when executed by a processor, implements a method for determining goods volume as provided in an embodiment of the present invention, the method including:
in response to detecting that a new stacking operation of a current SKU item is completed, searching for a stacking location set involved in the new stacking operation;
for each stacking location in the stacking location set, determining a current upper limit of unit volume of the current SKU item in the stacking location according to a location volume of the stacking location and a storage quantity of the current SKU item in the stacking location; and updating a historical volume of the current SKU item according to the current upper limit of unit volume of the current SKU item on each stacking location.

The computer storage medium in the embodiment of the present invention can be any combination of one or more computer-readable media. The computer-readable medium can be a computer-readable signal medium or a computer-readable storage medium. The computer-readable storage medium can be, for example, but not limited to, an electronic, magnetic, optical, electromagnetic, infrared, or semiconductor system, apparatus or device, or any combination thereof. More specific examples (a non-exhaustive list) of the computer-readable storage medium include: an electrical connection with one or more conducting wires, a portable computer disc, a hard disc, an random access memory (RAM), a read only memory (ROM), an erasable programmable read only memory (EPROM or flash memory), an optical fiber, a portable compact disk-read only memory (CD-ROM), an optical storage device, a magnetic storage device, or any suitable combination thereof. As used herein, a computer-readable storage medium can be any tangible medium that contains or stores a program that can be used by or in combination with an instruction execution system, apparatus or device.

The computer-readable signal medium can include a data signal propagated in a baseband or as part of a carrier wave, and the data signal carries computer-readable program codes. Such a propagated data signal can take many forms, including but not limited to an electromagnetic signal, an optical signal, or any suitable combination thereof. The computer-readable signal medium may also be any computer-readable medium other than a computer-readable storage medium, and the computer-readable medium can send, propagate or transmit a program for use by or in connection with an instruction execution system, apparatus or device.

The program codes included in the computer-readable medium can be transmitted by using any appropriate medium, including but not limited to a wireless, wire, optical cable, or RF medium, or any suitable combination thereof.

The computer program codes for performing the operations of the present invention can be written in one or more programming languages or a combination thereof, the programming languages including an object-oriented programming language such as Java, Smalltalk, or C ++, and also including a conventional procedural programming language, such as “C” or similar programming language. The program codes can be executed entirely on a user's computer, partly on a user's computer, as an independent software package, partly on a user's computer and partly on a remote computer, or entirely on a remote computer or server. In the case where a remote computer is involved, the remote computer can be connected to a user's computer through any type of network, including an local area network (LAN) or wide area network (WAN), or it can be connected to an external computer (such as being connected through the Internet from an Internet service provider).

It is to be noted that described above are only preferred embodiments of the present invention and technical principles applied thereto. Those skilled in the art can understand that the present invention is not limited to the specific embodiments described herein, and those skilled in the art can make various obvious changes, readjustments and substitutions without departing from the scope of protection of the present invention. Therefore, although the present invention is described in detail through the above embodiments, the present invention is not merely limited to the above embodiments. More other equivalent embodiments may also be included without departing from the concept of the present invention, and the scope of the present invention is determined by the scope of the appended claims.

What is claimed is:

1. An order processing method, comprising:
determining an actual volume of at least one type of an item of a plurality of items associated with an order, wherein the actual volume of the at least one type of the item of the plurality of items is determined based on a historical maximum storage quantity of the item of the plurality of items in a location and a volume of accommodation in the location, or determined based on a storage quantity of the item of the plurality of items in a turnover box and a volume of the turnover box;
determining a total volume of the plurality of items associated with the order according to the actual volume of the at least one type of the item of the plurality of items associated with the order; and
allocating the turnover box to the order according to the total volume of the plurality of items and the volume of the turnover box.

2. The method according to claim 1, wherein the plurality of items associated with the order is of one type, and after allocating the turnover box to the order according to the total volume of the plurality of items and the volume of the turnover box, the method further comprises:
when the actual volume of the at least one type of the item of the plurality of items is determined based on the historical maximum storage quantity of the item of the plurality of items in the location and the volume of accommodation in the location, and an instruction for separating the plurality of items in the turnover box is received after the turnover box is allocated, determining the actual volume of the at least one type of the item of the plurality of items again according to the storage quantity of the at least one type of the item of the plurality of items in the turnover box and the volume of the turnover box.

3. The method according to claim 2, wherein after updating the actual volume of the at least one type of the item of the plurality of items, the method further comprises:
updating the actual volume of the at least one type of the item of the plurality of items, according to the actual volume of the type of the item of the plurality of items determined again.

4. The method according to claim 1, wherein determining the actual volume of the at least one type of the item of the plurality of items based on the historical maximum storage quantity of the at least one type of the item of the plurality of items in the location and the volume of accommodation in the location comprises:
traversing the at least one type of the item of the plurality of items on a plurality of locations of a plurality of shelves in a warehouse, and determining the location storing a largest quantity of the type of item of the plurality of items and a current maximum storage quantity of the at least one type of the item of the plurality of items in the location;
when the current maximum storage quantity of the at least one type of the item of the plurality of items is greater than a stored historical maximum storage quantity of the at least one type of the item of the plurality of items, updating and saving the historical maximum storage quantity of the at least one type of the item of the plurality of items according to the current maximum storage quantity of the at least one type of the item of the plurality of items;
determining an effective volume of accommodation in the location storing the largest quantity of the at least one type of the item of the plurality of items; and
determining an estimated volume of the at least one type of the item of the plurality of items according to the historical maximum storage quantity of the at least one type of the item and the effective volume of accommodation in the location storing the largest quantity of the at least one type of the item, and using the estimated volume of the at least one type of the item as the actual volume of the at least one type of the item of the plurality of items.

5. The method according to claim 4, wherein after using the estimated volume of the at least one type of the item of the plurality of items as the actual volume of the at least one type of the item of the plurality of items, the method comprises:
determining a basic volume value of the at least one type of the item of the plurality of items; and
comparing the estimated volume of the at least one type of the item of the plurality of items with the basic volume value of the at least one type of the item of the plurality of items, and in response to that a comparison result indicates inconsistency, updating the basic volume value of the at least one type of the item of the plurality of items according to the estimated volume of the at least one type of the item of the plurality of items.

6. The method according to claim 4, wherein determining the effective volume of accommodation in the location storing the largest quantity of the at least one type of the item of the plurality of items comprises:
determining the effective volume of accommodation in the location storing the largest quantity of the at least one type of the item of the plurality of items according to the volume of accommodation in the location storing the largest quantity of the at least one type of the item of the plurality of items and a preset threshold of an effective space utilization rate of the location.

7. The method according to claim 5, wherein determining the basic volume value of the at least one type of the item of the plurality of items comprises:
receiving volume field information of the at least one type of the item of the plurality of items, and initializing the basic volume value of the at least one type of the item of the plurality of items according to the volume field information; or
based on an item type, acquiring an average volume value of the item type from an item statistics table, and initializing the basic volume value of the at least one type of the item of the plurality of items according to the average volume value of the item type.

8-14. (canceled)

15. A server, comprising:
at least one processor; and
a storage device configured to store at least one program, wherein
the at least one program, when executed by the at least one processor, causes the at least one processor to implement:
determining an actual volume of at least one type of an item of the plurality of items associated with an order, wherein the actual volume of the at least one type of the item of the plurality of items is determined based on a historical maximum storage quantity of the item of the plurality of items in a location and a volume of accommodation in the location, or determined based on a storage quantity of the item of the plurality of items in a turnover box and a volume of the turnover box;
determining a total volume of the plurality of items associated with the order according to the actual volume of the at least one type of the item of the plurality of items associated with the order; and
allocating the turnover box to the order according to the total volume of the plurality of items and the volume of the turnover box.

16. A storage medium storing a computer program, wherein the computer program, when executed by a processor, implements the order processing method according to claim 1.

17. A method for estimating goods volume, comprising:
searching for a location set involved in a new stacking operation, when detecting the new stacking operation of a current Stock Keeping Unit (SKU) item is completed;
for each location in the location set, determining a current upper limit of a unit volume of the current SKU item in a location according to a location volume of accommodation in the location and a storage quantity of the current SKU item in the location; and
updating a historical volume of the current SKU item according to the current upper limit of the unit volume of the current SKU item on the each location.

18. The method according to claim 17, wherein determining the current upper limit of the unit volume of the current SKU item in the location according to the location volume of accommodation in the location and the storage quantity of the current SKU item in the location comprises:
determining an effective space utilization rate of the location when the current SKU item uses the location; and
determining the current upper limit of the unit volume of the current SKU item in the location according to the location volume of accommodation in the location, the storage quantity of the current SKU item in the location, and the effective space utilization rate of the location.

19. The method according to claim 17, wherein the historical volume of the current SKU item comprises:
when an operation of updating the historical volume of the current SKU item is not performed for a first time, an updated volume of the current SKU item determined by a previous update serving as the historical volume of the current SKU item; or
when the operation of updating the historical volume of the current SKU item is performed for the first time, an initialized volume of the current SKU item serving as the historical volume of the current SKU item.

20. The method according to claim 19, wherein the updating of the historical volume of the current SKU item according to the current upper limit of the unit volume of the current SKU item on the each location comprises:
selecting the current upper limit of the unit volume, wherein the current upper limit of the unit volume meets a first preset criterion from a plurality of current upper limits of the unit volume of the current SKU item on the each location; and
in response to that the current upper limit of the unit volume, wherein the current upper limit of the unit meets the first preset criterion is smaller than the historical volume of the current SKU item, using the current upper limit of the unit volume that meets the first preset criterion as the updated volume of the current SKU item.

21. The method according to claim 19, the updating of the historical volume of the current SKU item according to the current upper limit of the unit volume of the current SKU item on the each location comprises:
for a current unit volume limit of the current SKU item in the each location, determining whether the current unit volume limit of the current SKU item in the location is smaller than the historical volume of the current SKU item;
in response to that the current upper limit of the unit volume of the current SKU item in the location is smaller than the historical volume of the current SKU item, using the current upper limit of the unit volume of the current SKU item in the location as a candidate volume; and
determining there is at least one candidate volume, selecting from the at least one candidate volume, a candidate volume that meets a second preset criterion as the updated volume of the current SKU item.

22. The method according to claim 19, wherein acquiring the initialized volume of the current SKU item comprises:
based on the current SKU item, searching, from historical inventory data, for a historical location set, wherein the historical location set has historically stored the current SKU item;
for each historical location in the historical location set, determining a historical upper limit of the unit volume of the current SKU item in a historical location according to a historical location volume of the historical location and the storage quantity of the current SKU item in the historical location; and
selecting, from a plurality of historical upper limits of the unit volume of the current SKU item in the each historical location, the historical upper limit of the unit volume that meets a third preset criterion as the initialized volume of the current SKU item.

23-28. (canceled)

29. A computer device, comprising:
at least one processor; and
a storage device configured to store at least one program, wherein
the at least one program, when executed by the at least one processor, causes the at least one processor to implement the method according to claim 17.

30. A computer-readable storage medium storing a computer program, wherein the program, when executed by a processor, implements the method according to claim 17.
